(19) United States
(12) Patent Application Publication
(10) Pub. No.: US 2023/0300962 A1
(43) Pub. Date: Sep. 21, 2023

(54) Wireless Control Based LED Driver Circuit

(71) Applicant: HongChun Zhao, ShenZhen (CN)

(72) Inventor: HongChun Zhao, ShenZhen (CN)

(21) Appl. No.: 17/721,788

(22) Filed: Apr. 15, 2022

(30) Foreign Application Priority Data
Mar. 21, 2022 (CN) 202220610705.5

(51) Int. Cl. H05B 47/19; H05B 45/325; H05B 45/44

(52) U.S. Cl. CPC H05B 47/19; H05B 45/325; H05B 45/44

(57) ABSTRACT

A wireless-control-based LED (Light-Emitting Diode) driver circuit is disclosed. A wireless module comprises a controller connected to an IR (infrared) wireless receiver, and further connected to one or more LED switch circuits. The controller sends PWM (Pulse Width Modulation) signals to the LED switch circuits to drive LEDs. Each LED switch circuit is connected to a power supply VCC, wherein an LED connected in parallel with a capacity is mounted between the LED switch circuit and the power supply VCC. The parallel-connected capacitor filters fluctuations of PWM signals and improves wireless sensitivity.

### FIELD OF TECHNOLOGY

The present disclosure relates to a wireless-control-based LED (Light Emitting Diode) driver circuit for driving LEDs and a wireless receiver, belonging to the field of driving technology.

### BACKGROUND

With the development of economy, more activities are carried out at night, and many products for night need to be shown by LED lamps. To be more interactive, remote control can be more diversified, so wireless remote control infrared (IR) control and the like combined with LED lamps appear in many occasions.

In use, a wireless (such as infrared) receiver head needs a transparent or translucent material for transmission, and lamps also need a transparent or translucent material to transmit light, so the LED lamps and the wireless remote control receiver head are often placed on the same side.

LEDs usually use PWM (Pulse Width Modulation) technology to control the brightness and color composition of the LEDs. This technology uses purely digital signals, so the LEDs either light up or go out with extreme fluctuations. The sensitivity (which directly influences the receiving performance and distance) of a wireless (such as infrared) remote control signal receiver head is often based on the fluctuation degree of ambient light as a reference. Therefore, the more violently the ambient light fluctuates, the lower the sensitivity is; and the more gently the ambient light fluctuates, the higher the sensitivity is. In the case the LED lamps and the wireless receiver head are on the same side, after the LED lamps light up, the LED lamps affect a wireless receiver, causing interference to the wireless receiver, resulting in poor receiving performance, and a sometimes far and sometimes near distance, which is unstable.

### SUMMARY OF THE INVENTION

A technical problem to be solved by the present disclosure is to provide a wireless-control-based LED driver circuit for filtering violent fluctuations of PWM signals, so that the signals tend to be smooth and wireless signal reception is sensitive.

To solve the above technical problem, the wireless-control-based LED driver circuit of the present disclosure includes a controller, the controller being connected to a wireless receiver, the controller being further connected to one or more LED switch circuits, and the controller sending PWM signals to the LED switch circuits to drive LEDs, wherein each LED switch circuit is connected to a power supply VCC (Common Collector Voltage), and an LED is mounted on a line between the LED switch circuit and the power supply VCC; and on the line between the LED switch circuit and the power supply VCC, the LED is connected in parallel with a capacitor.

Specifically, the LED switch circuit is a triode switch circuit. Optionally, the triode switch circuit includes an NPN-type (Negative-Positive-Negative) triode, and the controller is connected to a base of the triode, an emitter of the triode being connected to a ground terminal GND (Ground), a collector of the triode being connected to the power supply VCC, and the LED being mounted on a line between the collector of the triode and the power supply VCC; and on the line between the collector of the triode and the power supply VCC, the LED is connected in parallel with the capacitor. Alternatively, the triode switch circuit includes a PNP-type (Positive-Negative-Positive) triode, and the controller is connected to a base of the triode, a collector of the triode being connected to a ground terminal GND, an emitter of the triode being connected to the power supply VCC, and the LED being mounted on a line between the collector of the triode and the ground terminal GND; and on the line between the collector of the triode and the ground terminal GND, the LED is connected in parallel with the capacitor.

Specifically, the LED switch circuit is a MOSFET (Metal Oxide Semiconductor Field Effect Transistor) transistor circuit. Optionally, the MOSFET transistor circuit includes an N-type MOSFET transistor, and the controller is connected to a gate of the MOSFET transistor, a source of the MOSFET transistor being connected to a ground terminal GND, a drain of the MOSFET transistor being connected to the power supply VCC, and the LED being mounted on a line between the drain of the MOSFET transistor and the power supply VCC; and on the line between the drain of the MOSFET transistor and the power supply VCC, the LED is connected in parallel with the capacitor. Alternatively, the MOSFET transistor circuit includes a P-type MOSFET transistor, and the controller is connected to a gate of the MOSFET transistor, a drain of the MOSFET transistor being connected to a ground terminal GND, a source of the MOSFET transistor being connected to the power supply VCC, and the LED being mounted on a line between the drain of the MOSFET transistor and the ground terminal GND; and on the line between the drain of the MOSFET transistor and the ground terminal GND, the LED is connected in parallel with the capacitor.

The above-mentioned capacitor connected in parallel filters violent fluctuations of PWM signals, so that the signals tend to be smooth. The smoothness depends on the capacity of the capacitor. The larger the capacity, the smoother the signals are. The capacitance value of the capacitor is greater than or equal to 0.1 μF. A capacitance value below 0.1 μF has little influence on the circuit and is of no practical significance.

The capacitor is preferably an SMD (Surface Mounted Device) capacitor, not a plug-in capacitor that is large in volume, as circuit boards generally use SMT (Surface Mounted Technology) process.

The LED is an SMD LED, not a plug-in LED that is not as convenient as the SMD LED in terms of production process and ease of operation.

Specifically, the wireless receiver is an infrared receiver or an RF receiver.

The wireless-control-based LED driver circuit of the present disclosure has a simple layout and a low cost, greatly improves the performance of remote control, achieves a farther distance (increased by at least 50%), and is more reliable, and with the parallel-connected capacitor filtering violent fluctuations of PWM signals, the signals tend to be smooth, and wireless signal reception is sensitive.

### BRIEF DESCRIPTION OF DRAWINGS

The present disclosure is further described in detail below in conjunction with the accompanying drawings and specific implementations.

FIG. 1 is a circuit diagram of an infrared controlled NPN-type triode of the present disclosure.

FIG. 2 is a circuit diagram of an infrared controlled PNP-type triode of the present disclosure.

FIG. 3 is a circuit diagram of an infrared controlled N-type MOSFET transistor of the present disclosure.

FIG. 4 is a circuit diagram of an infrared controlled P-type MOSFET transistor of the present disclosure.

FIG. 5 is a circuit diagram of an RF controlled NPN-type triode of the present disclosure.

FIG. 6 is a graph of waveform test results.

### DETAILED DESCRIPTIONS OF EMBODIMENTS

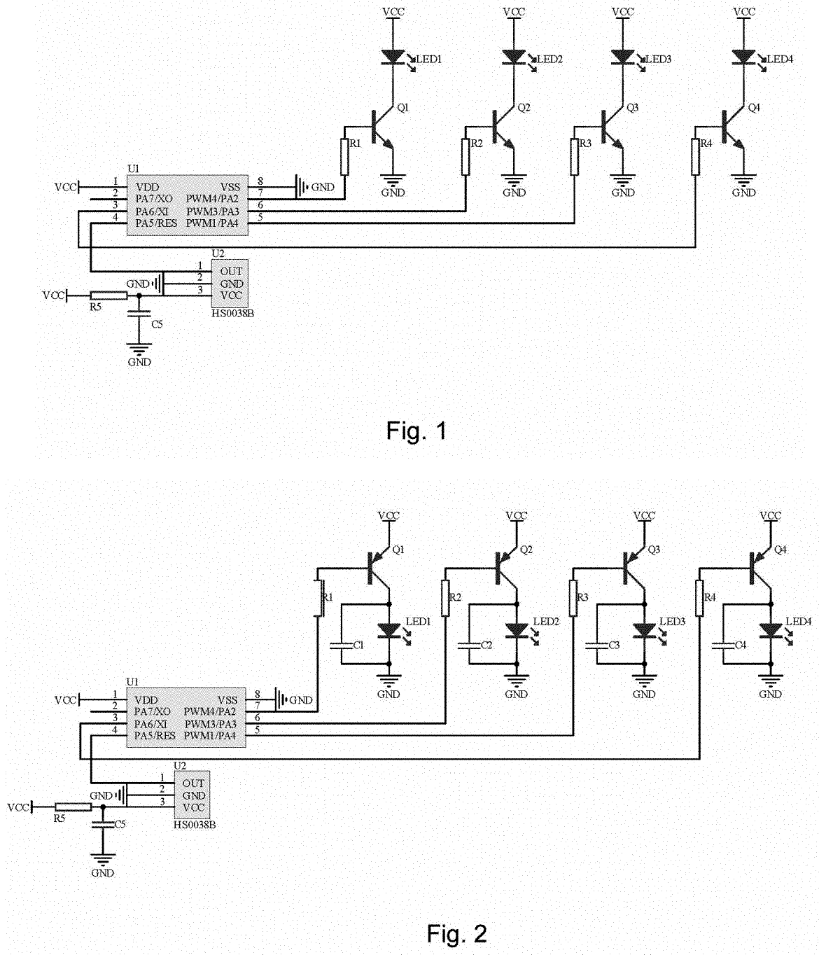

As shown in FIG. 1, a wireless-control-based LED driver circuit includes a controller (optionally a single-chip microcomputer), which is connected to an infrared wireless receiver for infrared signal reception. The controller is further connected to four (not limited in number) LED switch circuits, and the controller sends PWM signals to the LED switch circuits to drive LEDs.

As shown in FIG. 1, the LED switch circuits are triode switch circuits; each triode switch circuit includes an NPN-type triode, and the controller is connected to a base of the triode, an emitter of the triode being connected to a ground terminal GND, a collector of the triode being connected to a power supply VCC, and an LED being mounted on a line between the collector of the triode and the power supply VCC; and on the line between the collector of the triode and the power supply VCC, the LED is connected in parallel with a capacitor.

As shown in FIG. 2, the LED switch circuits are triode switch circuits; each triode switch circuit includes a PNP-type triode, and the controller is connected to a base of the triode, a collector of the triode being connected to a ground terminal GND, an emitter of the triode being connected to a power supply VCC, and an LED being mounted on a line between the collector of the triode and the ground terminal GND; and on the line between the collector of the triode and the ground terminal, the LED is connected in parallel with a capacitor.

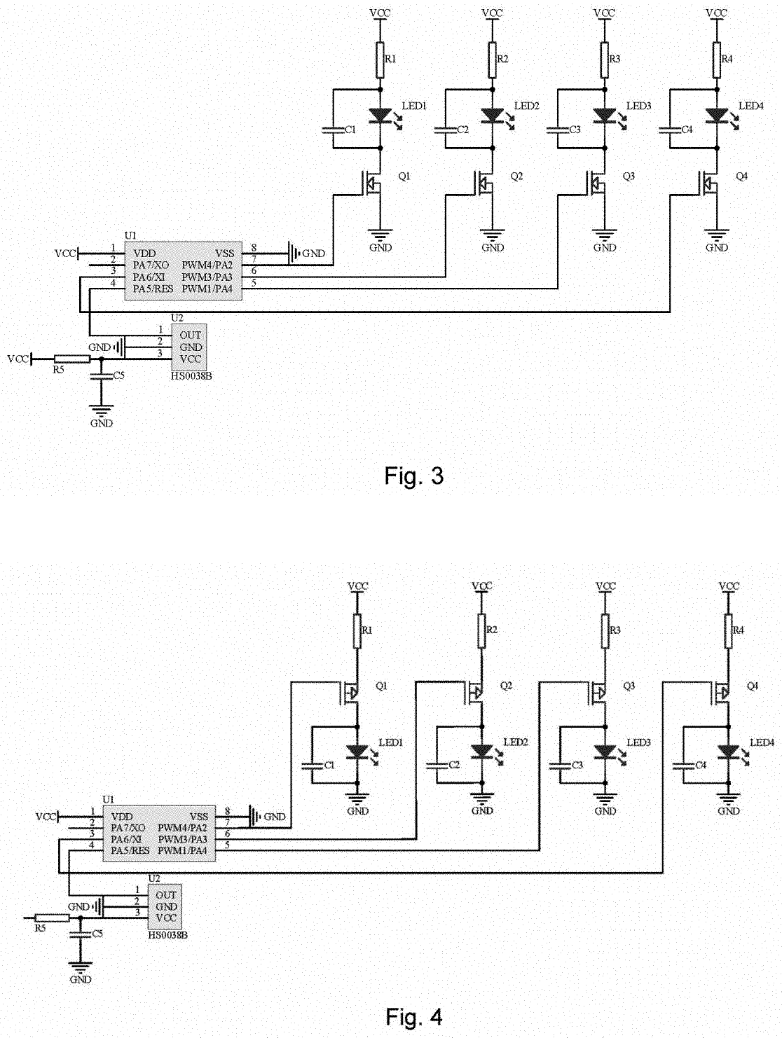

As shown in FIG. 3, the LED switch circuits are MOSFET transistor circuits; each MOSFET transistor circuit includes an N-type MOSFET transistor, and the controller is connected to a gate of the MOSFET transistor, a source of the MOSFET transistor being connected to a ground terminal GND, a drain of the MOSFET transistor being connected to a power supply VCC, and an LED being mounted on a line between the drain of the MOSFET transistor and the power supply VCC; and on the line between the drain of the MOSFET transistor and the power supply VCC, the LED is connected in parallel with a capacitor.

As shown in FIG. 4, the LED switch circuits are MOSFET transistor circuits; each MOSFET transistor circuit includes a P-type MOSFET transistor, and the controller is connected to a gate of the MOSFET transistor, a drain of the MOSFET transistor being connected to a ground terminal GND, a source of the MOSFET transistor being connected to the power supply VCC, and an LED being mounted on a line between the drain of the MOSFET transistor and the ground terminal GND; and on the line between the drain of the MOSFET transistor and the ground terminal, the LED is connected in parallel with a capacitor.

The above-mentioned LEDs are SMD LEDs, and the capacitors are SMD capacitors with capacitance values greater than or equal to 0.1 μF, such as capacitors of 10 μF.

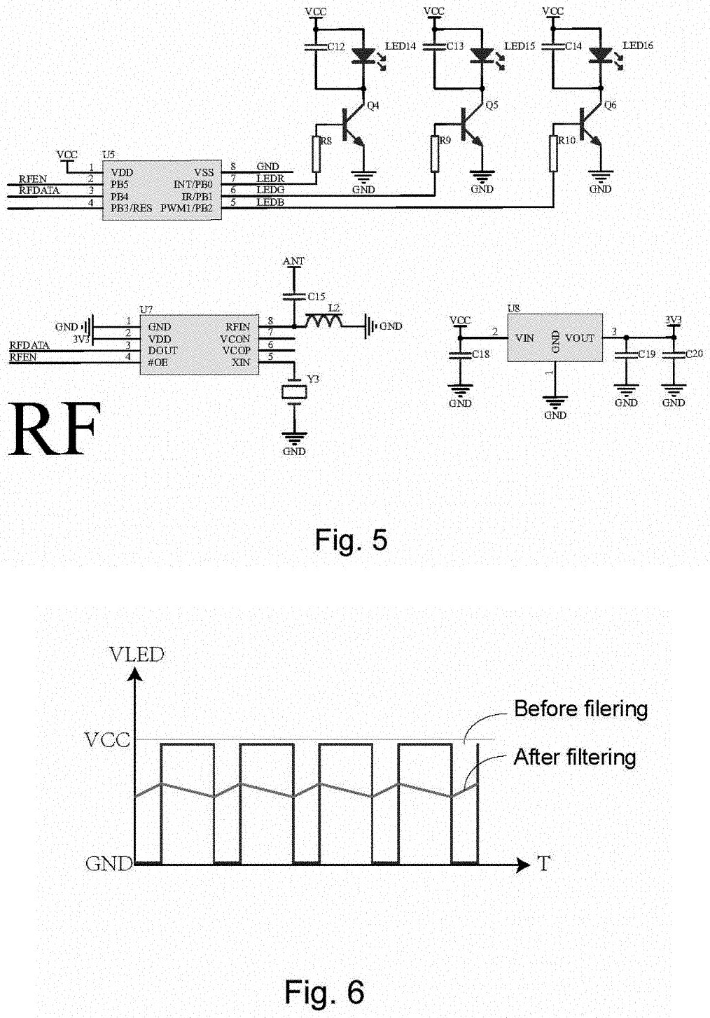

As shown in FIG. 5, the wireless receiver may also be an RF receiver, and the LED switch circuits may be any of the types shown in FIGS. 1-4, which can all achieve a good effect.

The circuit in FIG. 1 is tested (test points are the collector of the transistor Q1, and the ground terminal GND connected with the capacitor C5) to obtain a waveform test result when the capacitor is removed and a waveform test result when the capacitor is retained, as shown in FIG. 6, without the capacitor connected in parallel (before filtering), the voltage waveform of the LED fluctuates up and down greatly, and with the capacitor connected in parallel (after filtering), the waveform of the LED fluctuates very little. Similarly, the circuits in FIGS. 2 to 5 are tested to obtain waveform test results also as shown in FIG. 6.

The above embodiments do not limit the present disclosure in any way, and all technical solutions obtained by equivalent substitution or equivalent transformation fall within the scope of protection of the present disclosure.

What is claimed is:

1. A wireless-control-based LED driver circuit comprising:
a wireless module which comprises a controller connected to an infrared wireless receiver, wherein the controller is connected to at least one LED switch circuit, and sends PWM signals to the LED switch circuits to drive LEDs,
wherein each LED switch circuit is further connected to a power supply VCC, with an LED connected in parallel with a capacitor mounted between the LED switch circuit and the power supply VCC.

2. The wireless-control-based LED driver circuit according to claim 1, wherein the LED switch circuit is a triode switch circuit.

3. The wireless-control-based LED driver circuit according to claim 2, wherein the triode switch circuit comprises an NPN-type triode, and the controller is connected to a base of the triode, an emitter of the triode being connected to a ground terminal GND, a collector of the triode being connected to the power supply VCC, and the LED being mounted on a line between the collector of the triode and the power supply VCC; and on the line between the collector of the triode and the power supply VCC, the LED is connected in parallel with the capacitor.

4. The wireless-control-based LED driver circuit according to claim 2, wherein the triode switch circuit comprises a PNP-type triode, and the controller is connected to a base of the triode, a collector of the triode being connected to a ground terminal GND, an emitter of the triode being connected to the power supply VCC, and the LED being mounted on a line between the collector of the triode and the ground terminal GND; and on the line between the collector of the triode and the ground terminal GND, the LED is connected in parallel with the capacitor.

5. The wireless-control-based LED driver circuit according to claim 1, wherein the LED switch circuit is a MOSFET transistor circuit.

6. The wireless-control-based LED driver circuit according to claim 5, wherein the MOSFET transistor circuit comprises an N-type MOSFET transistor, and the controller is connected to a gate of the MOSFET transistor, a source of the MOSFET transistor being connected to a ground terminal GND, a drain of the MOSFET transistor being connected to the power supply VCC, and the LED being mounted on a line between the drain of the MOSFET transistor and the power supply VCC; and on the line between the drain of the MOSFET transistor and the power supply VCC, the LED is connected in parallel with the capacitor.

7. The wireless-control-based LED driver circuit according to claim 5, wherein the MOSFET transistor circuit comprises a P-type MOSFET transistor, and the controller is connected to a gate of the MOSFET transistor, a drain of the MOSFET transistor being connected to a ground terminal GND, a source of the MOSFET transistor being connected to the power supply VCC, and the LED being mounted on a line between the drain of the MOSFET transistor and the ground terminal GND; and on the line between the drain of the MOSFET transistor and the ground terminal, the LED is connected in parallel with the capacitor.

8. The wireless-control-based LED driver circuit according to claim 1, wherein the capacitor comprises a capacitance value greater than or equal to 0.1 μF.

9. The wireless-control-based LED driver circuit according to claim 1, wherein the capacitor is an SMD capacitor.

10. The wireless-control-based LED driver circuit according to claim 1, wherein the LED is an SMD LED.

11. (canceled)
